(19) United States
(12) Patent Application Publication
(10) Pub. No.: US 2024/0069155 A1
(43) Pub. Date: Feb. 29, 2024

(54) RADAR APPARATUS

(71) Applicant: DENSO CORPORATION, Kariya-city (JP)

(72) Inventors: Yusuke TAINAKA, Kariya-city (JP); Ryuji AOKI, Kariya-city (JP); Akihumi KURITA, Kariya-city (JP)

(21) Appl. No.: 18/494,685

(22) Filed: Oct. 25, 2023

Related U.S. Application Data
(63) Continuation of application No. PCT/JP2022/018885, filed on Apr. 26, 2022.

(30) Foreign Application Priority Data
Apr. 27, 2021 (JP) 2021-074842

(51) Int. Cl. G01S 7/03; G01S 7/02; G01S 13/931; H01Q 1/32; H01Q 1/42; H01Q 21/06

(52) U.S. Cl. CPC G01S 7/03; G01S 7/023; G01S 13/931; H01Q 1/3233; H01Q 1/42; H01Q 21/065; G01S 2013/93275

(57) ABSTRACT

A radar apparatus includes an antenna unit, a cover portion, and a radio-wave suppression portion. The antenna unit includes an antenna surface in which one or more antennas that radiate radio waves are provided and is configured to emit a target radio wave of a predetermined frequency band. The cover portion is configured to be provided in a position through which the target radio wave passes. The radio-wave suppression portion is integrated with the cover portion in an out-of-detection-range area, of an outer surface of the cover portion, that is an area outside a range of a detection angle of the antenna portion, and includes a conductive portion that has conductivity and a non-conductive portion that does not have conductivity.

### CROSS-REFERENCE TO RELATED APPLICATION

The present application is a continuation application of International Application No. PCT/JP2022/018885, filed on Apr. 26, 2022, which claims priority to Japanese Patent Application No. 2021-074842, filed on Apr. 27, 2021. The contents of these applications are incorporated herein by reference in their entirety.

### BACKGROUND

### Technical Field

The present disclosure relates to a radar apparatus.

### Related Art

A millimeter-wave radar that is used for purposes such as autonomous driving and collision avoidance of a vehicle is known. The millimeter-wave radar is a radar for detecting a presence of an object inside a predetermined detection area and a distance to the object, by emitting radio waves and detecting reflected waves that are the emitted radio waves reflected by the object.

### SUMMARY

An aspect of the present disclosure provides a radar apparatus, and includes an antenna unit, a cover portion, and a radio-wave suppression portion. The antenna unit includes an antenna surface in which one or more antennas that radiate radio waves are provided and is configured to emit a target radio wave of a predetermined frequency. The cover portion is configured to be provided in a position through which the target radio wave passes. The radio-wave suppression portion is integrated with the cover portion in an out-of-detection-range area, of an outer surface of the cover portion, that is an area that is outside a range of a detection angle of the antenna portion, and includes a conductive portion that has conductivity and a non-conductive portion that does not have conductivity.

### BRIEF DESCRIPTION OF THE DRAWINGS

In the accompanying drawings:

FIG. 1 is a perspective view of a radar apparatus according to an embodiment;

FIG. 2 is a cross-sectional view taken along line II-II in FIG. 1;

FIG. 3 is a cross-sectional view taken along line in FIG. 1;

FIG. 4 is an explanatory diagram in which a configuration of an antenna unit 341 is projected onto a cross-sectional view taken along line IV-IV in FIG. 3;

FIG. 5 is an explanatory diagram for explaining an out-of-detection-range area;

FIG. 6 is an explanatory diagram for explaining a radio-wave suppression portion according to the embodiment;

FIG. 7 is an explanatory diagram for explaining the radio-wave suppression portion according to the embodiment;

FIG. 8 is an explanatory diagram for explaining unwanted waves;

FIG. 9 is an explanatory diagram for explaining workings of the radio-wave suppression portion according to the embodiment;

FIG. 10 is an explanatory diagram for explaining the radio-wave suppression portion in a first modification;

FIG. 11 is an explanatory diagram for explaining subjects of simulation;

FIG. 12 is a graph of improving effects of S11 based on simulations;

FIG. 13 is a graph of improving effects of S21 based on simulations;

FIG. 14 is an explanatory diagram for explaining an example in which a radio-wave suppression portion is provided on a radome non-opposing surface according to another embodiment;

FIG. 15 is an explanatory diagram for explaining an example in which a radio-wave suppression portion is provided on a bumper opposing surface according to another embodiment; and

FIG. 16 is an explanatory diagram for explaining an example in which the radio-wave suppression portion of the first modification is provided on the bumper opposing surface according to another embodiment.

### DESCRIPTION OF THE EMBODIMENTS

Performance of the millimeter-wave radar degrades when evaluation is performed while the millimeter-wave radar is mounted in a vehicle, compared to when evaluation is performed on the millimeter-wave radar alone. Degradation of performance occurs as a result of unwanted waves, which are radio waves that stray outside the detection area or radio waves that enter an unintended area, acting as interference waves that disturb a phase of radar waves and cause errors in orientation detection of the object. For example, as a significant unwanted wave, a reflected wave from a bumper is known.

US 2020/0243960 A1 discloses a technology in which effects of unwanted waves are suppressed by an absorbing element that is formed from a material that absorbs electromagnetic waves being provided in a radar apparatus.

In the radar apparatus described in US 2020/0243960 A1, described above, the absorbing element is required to be set as a new component. Therefore, an issue has been found in that cost of manufacturing increases. In addition, a new issue has also been found in that variations in setup accuracy when the absorbing element is provided are a factor that causes errors in orientation detection of an object.

It is thus desired to provide a technology that solves issues that may occur when the absorbing element is provided and reduces orientation detection errors by a radar apparatus.

An exemplary embodiment of the present disclosure provides a radar apparatus, and includes an antenna unit, a cover portion, and a radio-wave suppression portion. The antenna unit includes an antenna surface in which one or more antennas that radiate radio waves are provided and is configured to emit a target radio wave of a predetermined frequency. The cover portion is configured to be provided in a position through which the target radio wave passes. The radio-wave suppression portion is integrated with the cover portion in an out-of-detection-range area, of an outer surface of the cover portion, that is an area that is outside a range of a detection angle of the antenna portion, and includes a conductive portion that has conductivity and a non-conductive portion that does not have conductivity.

As a result of a configuration such as this, the radio-wave suppression portion suppresses unwanted waves that propagate outside the radar apparatus and unwanted waves that propagate into the radar apparatus. Consequently, these unwanted waves interfering with a direct wave that is radiated inside a detection area and thereby causing errors in orientation detection can be suppressed. In addition, because an absorbing element is not required to be newly provided, cost of manufacturing and orientation detection errors that may occur based on variations in setup accuracy when the absorbing element is provided can be suppressed. That is, issues that may occur when the absorbing element is provided can be solved and orientation detection errors by the radar apparatus can be reduced.

Embodiments of the present disclosure will hereinafter be described with reference to the drawings. Here, “perpendicular” is not limited to perpendicular in the strict sense and may not be perpendicular in the strict sense should similar effects be achieved. This similarly applies to “odd multiple” and “equal.”

### EMBODIMENTS

### 1. Configuration

An exemplary embodiment of the present disclosure will be described below with reference to the drawings.

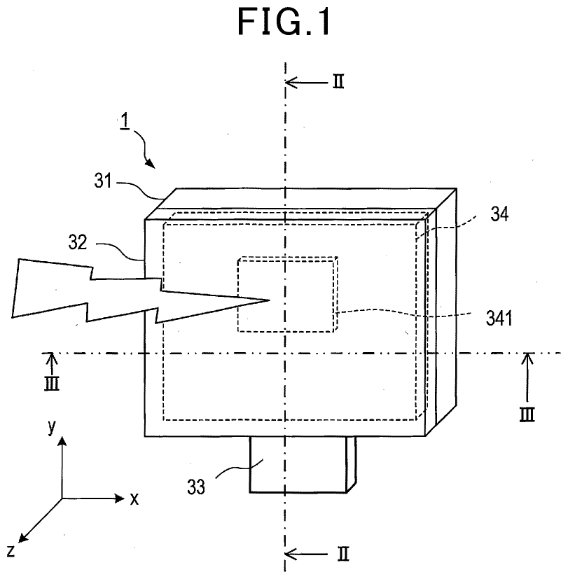

A radar apparatus 1 according to the present embodiment shown in FIG. 1 is mounted in a vehicle. The radar apparatus 1 is an apparatus for measuring at least a distance to an object that is present inside a predetermined detection range by transmitting and receiving a target radio wave. The target radio wave is a radio wave of a predetermined frequency band. For example, a millimeter wave is used. According to the present embodiment, a millimeter wave that has a frequency in a 77 GHz band is used. However, the frequency that is used is not limited thereto.

For example, the radar apparatus 1 is fixed to a metal plate surface that is a portion of a body 9 of the vehicle that is positioned on an inner side of a bumper 8 of the vehicle.

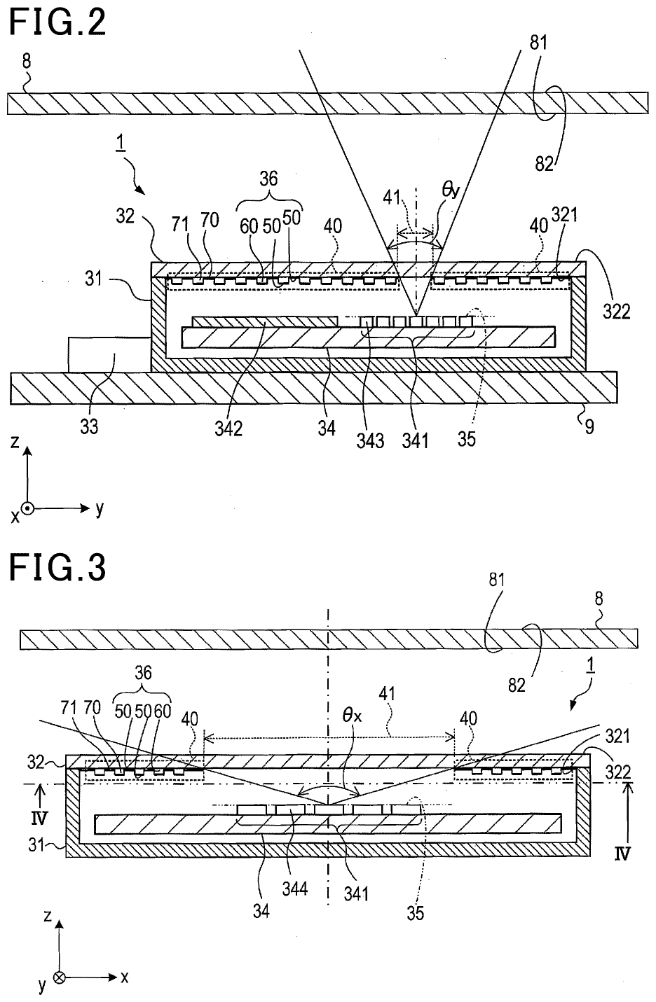

As shown in FIGS. 2 to 4, the radar apparatus 1 includes a lower case 31, a radome 32, a connector 33, a circuit board 34, and a radio-wave suppression portion 36.

The lower case 31 is a box-shaped member that is formed from a material that does not allow radio waves to pass. The lower case 31 is formed to have an outer shape that is a rectangular parallelopiped of which one face is open.

The radome 32 is a plate-shaped member that is formed from a resin material that allows radio waves to pass. The radome 32 is provided in a position through which the target radio wave passes. The radome 32 is attached to the lower case 31 so as to seal the opening of the lower case 31.

The lower case 31 and the radome 32 form a space in which the circuit board 34 is housed. The lower case 31 and the radome 32 in combination are also referred to as a housing.

The connector 33 is provided on a side wall of the lower case 31. The connector 33 is used to electrically connect an electronic circuit (that is, a transmission/reception circuit unit 342 described hereafter) on the circuit board 34 and the vehicle in which the radar apparatus 1 is mounted.

The circuit board 34 includes an antenna unit 341 and the transmission/reception circuit unit 342.

For example, the antenna unit 341 is configured by a plurality of patch antennas 343 being arranged in a two-dimensional array, and transmits and receives the target radio wave. A surface on which the antenna unit 341 is configured is referred to as an antenna surface 35.

Here, a long-side direction of the circuit board 34 is an x-axis direction, a short-side direction is a y-axis direction, and an axial direction that is perpendicular to the antenna surface 35 is a z-axis direction. Hereafter, descriptions will be made with reference to these xyz three-dimensional coordinate axes as appropriate. Here, with the antenna surface 35 as a boundary, a side to which radiated waves are radiated is a positive side of the z axis and a side opposite thereto is a negative side of the z-axis.

The plurality of patch antennas 343 being arranged in a two-dimensional array refers to the plurality of patch antennas 343 being two-dimensionally arrayed along both the x-axis direction and the y-axis direction.

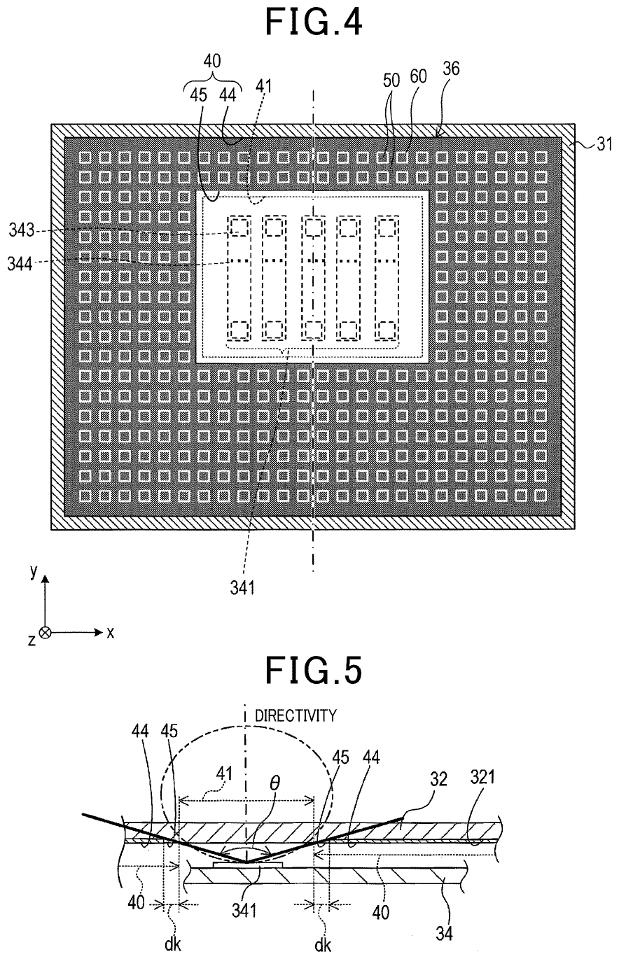

Here, as shown in FIGS. 2 and 4, the plurality (such as seven) patch antennas 343 that are arranged in a single row along the y-axis direction is configured to function as a single array antenna (hereafter, a unit antenna 344). That is, as shown in FIGS. 3 and 4, the antenna unit 341 has a structure in which a plurality (such as five) unit antennas 344 are arrayed along the x-axis direction. However, the number of patch antennas 343 that are included in the unit antenna 344 and the number of unit antennas 344 that are included in the antenna unit 341 are not limited thereto.

For example, any one of the plurality of unit antennas 344 may be used as a transmission antenna and the other unit antennas 344 may be used as a reception antenna. That is, in the radar apparatus 1, the x-axis direction that is the array direction of the unit antennas 344 is an orientation detection direction. However, a mode of the transmission antenna and the reception antenna is not limited thereto. Numbers and arrangements of the unit antennas 344 that are used as the transmission antenna and the unit antennas 344 that are used as the reception antenna can be arbitrarily set. In addition, all unit antennas 344 may be used as the transmission antenna and all unit antennas 344 may be used as the reception antenna.

The transmission/reception circuit unit 342 includes a circuit that generates a transmission signal that is supplied to the antenna unit 341 based on a command that is inputted through the connector 33. In addition, the transmission/reception circuit unit 342 includes a circuit that performs signal processing such as down conversion on a reception signal that is supplied from the antenna unit 341 and outputs the signal through the connector 33, and the like.

Hereafter, the xyz-axis directions of the circuit board 34 also apply to the radar apparatus 1 in which the circuit board 34 is attached to the lower case 31. Here, the radar apparatus 1 is fixed such that the y-axis direction coincides with a vehicle height direction, the x-axis direction coincides with a horizontal direction, and the z-axis direction coincides with a center direction of the detection area.

As shown in FIG. 3, the detection area includes an area over a predetermined angular range (also referred to, hereafter, as a predetermined angular range Ox) in which, with a center of the antenna surface 35 as a point of origin, a normal direction of the antenna surface 35 on an x-z plane, that is, the z-axis direction is 0°. For example, the predetermined angular range is set to −60° to +60°. However, the predetermined angular range is not limited to −60° to +60° and may be set to a narrower angle or a wider angle.

In addition, as shown in FIG. 2, the detection area includes an area over a predetermined angular range (also referred to, hereafter, as a predetermined angular range θy) in which, with the center of the antenna surface 35 as the point of origin, a normal direction of the antenna surface 35 on an y-z plane, that is, the z-axis direction is 0°. The predetermined angular range θy is set to a narrower angle than the predetermined angular range Ox.

As shown in FIGS. 2 to 4, the radome 32 includes the radio-wave suppression portion 36 on a radome opposing surface 321. The radome opposing surface 321 is a surface, among outer surfaces of the radome 32, that opposes (that is, faces) the antenna surface 35. The outer surface refers to an exposed surface. Here, among the outer surfaces of the radome 32, an outer surface that does not oppose the antenna surface 35 is referred to as a radome non-opposing surface 322.

Specifically, the radio-wave suppression portion 36 is provided within an out-of-detection-range area 40 of the radome opposing surface 321. As shown in FIG. 5, the out-of-detection-range area 40 is an area that is outside of a range of a detection angle of the antenna unit 341 (that is, the detection area of the antenna unit 341). 0 herein may be the Ox or Oy, described above. For example, an area (hereafter, a projection area 41) in which the range of the detection angle θ of the antenna unit 341 is projected onto the radome opposing surface 321 corresponds to an area that is within the range of the detection angle θ (that is, the detection area) of the antenna unit 341 on the radome opposing surface 321.

That is, the out-of-detection-range area 40 is an area that is outside the projection area 41 on the radome opposing surface 321. Here, as shown in FIG. 4, the radio-wave suppression portion 36 is provided over substantially an overall area of the out-of-detection-range area 40 on the radome opposing surface 321. Specifically, the radio-wave suppression portion 36 is provided in a remaining area (also referred to, hereafter, as a formation area 44) of the out-of-detection-range area 40 that excludes a reserve area 45 that is separated from the projection area 41 by a predetermined length dk. The formation area 44 refers to an area of the out-of-detection-range area 40 in which the radio-wave suppression portion 36 is provided (that is, formed). The predetermined length dk can be set as appropriate to a length that is to an extent that the radio-wave suppression portion 36 does not affect directivity of the antenna unit 341.

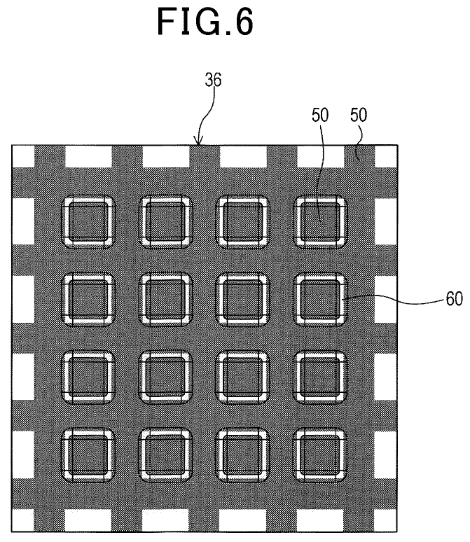

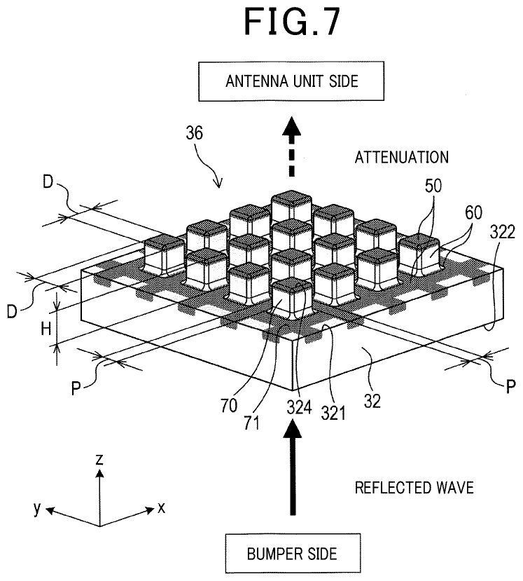

As shown in FIGS. 6 and 7, the radio-wave suppression portion 36 includes a conductive portion 50 that has conductivity and a non-conductive portion 60 that does not have conductivity. Having conductivity in this case refers to a conductivity of 1 S/m or greater. The conductive portion 50 is a portion of the radome opposing surface 321 in which material property of the radome 32 is changed. As a result of the material property of the radome 32 being changed, the conductive portion 50 has conductivity and is integrated with the radome 32. A remaining portion of the radio-wave suppression portion 36 other than the conductive portion 50 is referred to as the non-conductive portion 60.

The portion in which the material property of the radome 32 is changed is specifically a portion in which the resin that is the material of the radome 32 is carbonized. As a result of the resin being heated and carbonized, the material property can be changed to have conductivity. Here, the conductivity that is obtained by the resin being carbonized is about 10 to 100 S/m.

As the resin that serves as the material of the radome 32, an aromatic resin can be used. For example, the resin includes polybutylene terephthalate (PBT), polyphenylene sulfide (PPS), polyimide (PI), phenols, and the like.

That is, the conductive portion 50 is a portion of the radome opposing surface 321 that has conductivity as a result of the resin that is the material of the radome 32 being carbonized. Specifically, the resin is carbonized by being emitted by laser light. The conductive portion 50 is formed by the laser light being emitted as appropriate onto a section of the radome opposing surface 321 in which unwanted waves, described hereafter, are to be suppressed (that is, in this case, substantially the overall area of the out-of-detection-range area 40 of the radome opposing surface 321). In this manner, the radio-wave suppression portion 36 is integrated with the radome 32. Integrated in this case refers to being formed as a part of the radome 32 (that is, integrally formed) without a new component being added to the radome 32.

As shown in FIG. 7, in the radar apparatus 1, the radio-wave suppression portion 36 includes a plurality of protruding portions 70 that have a shape that protrudes from the radome opposing surface 321. The protruding portion 70 is formed from the same material as the radome 32. A remaining portion of the radio-wave suppression portion 36 that excludes the protruding portions 70, that is, a remaining portion within the formation area 44 of the radome opposing surface 321 that excludes the protruding portions 70 is referred to as a non-protruding portion 71.

Each protruding portion 70 has a substantially cubical shape. The plurality of protruding portions 70 are arrayed along an x-axis direction and a y-axis direction at a pitch interval P that is a predetermined interval. That is, a top surface 324 that is a surface of the protruding portion 70 that is a surface in the protruding direction (that is, the negative direction of the z-axis) has a substantially square shape. Here, a length of one side of the top surface 324 (that is, a width D of the protruding portion 70) and a protrusion height H of the protruding portion 70 from the radome opposing surface 321 are equal. In addition, the conductive portions 50 are formed on both of the top surfaces 324 that are the surfaces of the protruding portions 70 and are in the protruding direction (that is, the negative direction of the z-axis) and the non-protruding portion 71 of the radio-wave suppression portion 36.

Here, in the radio-wave suppression portion 36, when focus is placed on the top surfaces 324 of the protruding portions 70, the conductive portions 50 can be said to have a substantially square shape that is a predetermined shape, and be arrayed along the x-axis direction and the y-axis direction that are specific directions at the pitch interval P that is a predetermined interval. The specific direction is a direction in which the conductive portions 50 are arrayed. The conductive portions 50 of the protruding portions 70 are formed by the laser light being emitted in a substantially square shape successively at every pitch interval P, along the x-axis direction or along the y-axis direction.

Meanwhile, in the radio-wave suppression portion 36, with regard to the non-protruding portion 71, the conductive portions 50 can be said to have a straight-line shape that is a predetermined shape, and be arrayed along the x-axis direction and the y-axis direction that are specific directions at a predetermined interval (that is, the width D of the protruding portion 70). The straight line in this case refers to a straight line that has a line width that is the pitch interval P. The conductive portions 50 of the non-protruding portion 71 are formed by the laser light being emitted in the shape of a straight line that has a line width that is the pitch interval P successively at every width D of the protruding portion 70, along the x-axis direction or along the y-axis direction. That is, with regard to the non-protruding portion 71, the conductive portion 50 is formed into a lattice shape.

Here, a wavelength of the target radio wave that is transmitted and received by the antenna unit 341 is k, and the protrusion height H of the protruding portion 70 from the radome opposing surface 321 is set to H=λ/4. However, the protrusion height H is not strictly required to be H=λ/4, and a variance within about ±25%, for example, is possible. Here, the protrusion height H is merely required to be an odd multiple of λ/4. The odd number is expressed by 2n+1 (where n is an integer).

In addition, the width D of the protruding portion is set to D=λ/4. However, the width D is not strictly required to be D=λ/4, and a variance within about ±25%, for example, is possible. Here, the width D of the protruding portion 70 is merely required to be an odd multiple of λ/4.

Furthermore, the pitch interval P that is the interval of the protruding portions 70 is set to P=λ/4. However, the pitch interval P is not strictly required to be P=λ/4, and a variance within about ±25%, for example, is possible. Here, the pitch interval P is merely required to be an odd multiple of λ/4.

### 2. Workings

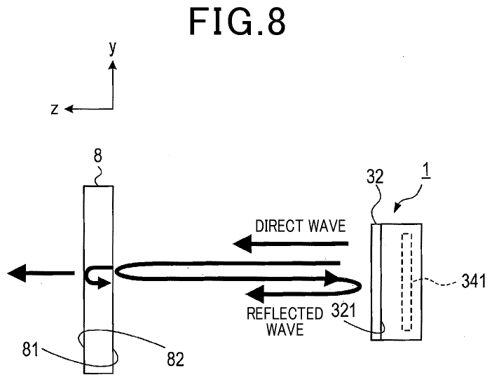

As shown in FIG. 8, in the vehicle, a radiating wave (also referred to, hereafter, as a direct wave) that is directly radiated from the radar apparatus 1 (that is, the antenna unit 341) is radiated outside the radar apparatus 1 through the radome 32. A portion of the direct wave may be reflected once by the bumper 8 or reflected multiple times between the bumper 8 and the radome 32 and become a reflected wave that propagates toward the radar apparatus 1 or a reflected wave that propagates toward the bumper 8. Here, a reflected wave that is a portion of the direct wave and propagates toward the radar apparatus 1 (that is, a reflected wave that propagates toward an interior of the housing of the radar apparatus 1) or propagates toward the bumper 8 as a result of reflection between the bumper 8 and the radome 32 is referred to as an unwanted wave. Such unwanted waves may cause errors in orientation detection by interfering with the direct wave (that is, a radar wave) that is radiated inside the detection area, outside the radar apparatus 1 and inside the radar apparatus 1.

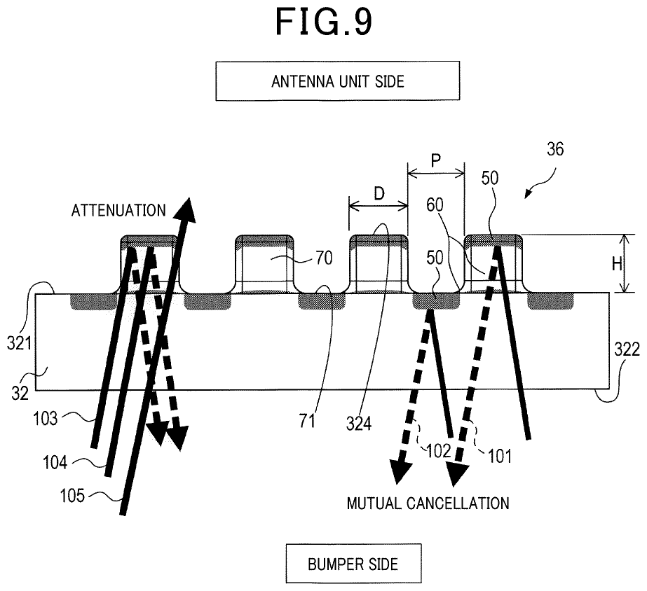

As shown in FIG. 9, in the radar apparatus 1, the protrusion height H of the protruding portion 70 in the radio-wave suppression portion 36 is set to H=λ/4. Therefore, a reflected wave 101 of the conductive portion 50 that is provided in the protruding portion 70 and a reflected wave 102 of the conductive portion 50 that is provided in the non-protruding portion 71 have phases that are shifted by almost 180°, and cancel each other out. That is, a reflection characteristic (that is, a so-called S11 characteristic) of the target wave in the radome 32 is a relatively small value at the frequency of the target radio wave.

Because, portions of the reflected wave that propagates from the bumper 8 toward the radome 32 cancel each other out in this manner as a result of the conductive portions 50 that are provided in the protruding portion 70 and the non-protruding portion 71, the reflected wave that is reflected by the radome 32 and again propagates toward the bumper 8 is suppressed. Therefore, the unwanted wave that propagates outside the radar apparatus 1 (that is, toward the bumper 8) is suppressed by the radio-wave suppression portion 36. Consequently, the unwanted wave interfering with the direct wave that is radiated inside the detection area and causing errors in orientation detection (that is, becoming an interference wave) as a result of multiple reflections with the bumper 8 and the like is suppressed.

In addition, as shown in FIG. 9, in the radar apparatus 1, the top surface 324 of the protruding portion 70 and the non-protruding portion 71 both have the conductive portions 50. Therefore, the reflected wave that propagates from the bumper 8 toward the radome 32 does not easily pass into the housing. A reason for this is that the reflected wave that propagates from the bumper 8 toward the radome 32 can only pass into the housing from a side surface of the protruding portion 70 excluding the top surface 324. For example, among a reflected wave 103 to a reflected wave 105 shown in FIG. 9, the reflected wave 105 passes into the housing. However, the reflected waves 103 and 104 are reflected by the conductive portion 50 and cannot pass into the housing.

In other words, reflected waves other than a reflected wave (such as the reflected wave 105) that propagates from the bumper 8 toward the radome 32 at a specific angle cannot pass into the housing. A transmission characteristic (that is, a so-called S21 characteristic) of the target wave in the radome 32 is a relatively small value. In this manner, a portion of the reflected wave that propagates from the bumper 8 toward the radome 32 passes into the housing after being attenuated by the conductive portions 50 that are provided in the protruding portions 70 and the non-protruding portion 71. Therefore, the unwanted wave that propagates into the radar apparatus 1 (that is, from the bumper 8) is suppressed by the radio-wave suppression portion 36. Consequently, the unwanted wave interfering with the direct wave that is radiated inside the detection area and causing errors in orientation detection (that is, becoming an interference wave) as a result of multiple reflections inside the radar apparatus 1 and the like is suppressed.

That is, the radio-wave suppression portion 36 is integrated with the radome 32, and as a result, in a manner similar to a so-called absorbing element that absorbs electromagnetic waves, works to suppress effects of unwanted waves on orientation detection errors regarding an object.

### 3. Effects

According to the embodiment described in detail above, following effects are achieved.

(3a) As a result of the radar apparatus 1, the radio-wave suppression portion 36 is integrated with the radome 32 in the out-of-detection-range area 40 of the radome opposing surface 321 of the radome 32, and includes the conductive portion 50 and the non-conductive portion 60.

The radio-wave suppression portion 36 suppresses unwanted waves that propagate outside of the radar apparatus 1 and unwanted waves that propagate into the radar apparatus 1. Therefore, these unwanted waves interfering with a direct wave that is radiated inside the detection area and thereby causing errors in orientation detection can be suppressed. In addition, because an absorbing element is not required to be newly provided, cost of manufacturing and the orientation detection errors that may occur based on variations in setup accuracy when the absorbing element is provided can be suppressed.

That is, issues that may occur when the absorbing element is provided can be solved and orientation detection errors by the radar apparatus 1 can be reduced. Furthermore, because the absorbing element or the like is not required to be newly provided separately from the radome 32 (such as on the circuit board 34), weight reduction of the radar apparatus 1 can be achieved and thinning of the radar apparatus 1 (that is, thinning of a thickness in the z-axis direction) can be achieved. In this manner, in the radar apparatus 1, the issues that may occur when the absorbing element is provided can be solved and orientation detection errors by the radar apparatus 1 can be reduced.

(3b) As a result of the radar apparatus 1, the conductive portion 50 is a portion in which the material property of the radome 32 is changed. Specifically, the portion in which the material property is changed is a portion in which the material is carbonized. Consequently, because a portion of the radome 32 becomes the conductive portion 50 (that is, the radio-wave suppression portion 36), cost of manufacturing can be further reduced. In addition, the radar apparatus 1 can be further reduced in weight and made thinner.

(3c) As a result of the radar apparatus 1, in the radio-wave suppression portion 36, the conductive portions 50 have a predetermined shape and are arrayed at a predetermined interval in a predetermined specific direction. That is, the conductive portions 50 are arrayed with periodicity in the specific direction. Therefore, compared to a case in which the conductive portions 50 are arrayed without periodicity, as a result of the shape, the interval, and the like of the conductive portions 50 being set as appropriate, a likelihood of the unwanted waves being reversed in phase and canceling each other out, and thereby being attenuated can be increased. Consequently, orientation detection errors by the radar apparatus 1 can be suppressed. In addition, because the conductive portions 50 are arrayed with periodicity, compared to a case in which the conductive portions 50 are arrayed without periodicity, work efficiency when carbonization is performed through emission of laser light can be improved.

(3d) As a result of the above-described radar apparatus 1, the radio-wave suppression portion 36 includes the protruding portions 70 and the non-protruding portion 71. The protruding portions 70 are arrayed at a predetermined interval along a specific direction. The conductive portion 50 is provided in at least either of the surface of the protruding portions 70 or the non-protruding portion 71. Therefore, as a result of the protrusion height H of the protruding portion 70 being appropriately set, the likelihood of the unwanted waves being reversed in phase and canceling each other out, and thereby being attenuated can be increased. In addition, because the radio-wave suppression portion 36 provides the conductive portion 50 in at least either of the surface of the protruding portions 70 and the non-protruding portion 71, the unwanted waves can be attenuated. Consequently, orientation detection errors by the radar apparatus 1 can be suppressed.

(3e) As a result of the above-described radar apparatus 1 in particular, the radio-wave suppression portion 36 includes the conductive portions 50 in both the non-protruding portion 71 and the surface of the protruding portions 70. As a result, compared to a case in which the conductive portion 50 is provided in either of the protruding portions 70 and the non-protruding portion 71, the radio-wave suppression portion 36 includes more conductive portions 50. Therefore, the unwanted waves can be further attenuated. Consequently, orientation detection errors by the radar apparatus 1 can be further suppressed.

(3f) As a result of the above-described radar apparatus 1, the protrusion height H of the protruding portion 70 is an odd multiple of λ/4. As a result, compared to a case in which the protrusion height H is not an odd multiple of λ/4, the likelihood of the unwanted waves being reversed in phase and canceling each other out, and thereby being attenuated can be further increased. Consequently, orientation detection errors by the radar apparatus 1 can be further suppressed.

(3g) In the radio-wave suppression portion 36, an interval between adjacent protruding portions 70 (that is, the pitch width P) is an odd multiple of λ/4 in the specific direction. As a result, the likelihood of the unwanted waves (such as the unwanted waves that propagate in the specific direction in particular) being reversed in phase and canceling each other out, and thereby being attenuated can be further increased. Consequently, orientation detection errors by the radar apparatus 1 can be further suppressed.

(3h) The specific direction in which the conductive portions 50 are arrayed with regularity includes the x-axis direction and the y-axis direction that is perpendicular to the x-axis direction. For example, when the shape of the conductive portion 50 is a straight line and such conductive portions 50 are arrayed in each of the x-axis direction and the y-axis direction, in the radio-wave suppression portion 36, the conductive portions 50 are arrayed perpendicular to each other in a lattice shape. Consequently, because the conductive portions 50 are perpendicular to each other, work efficiency when carbonization is performed through emission of laser light can be further improved.

Here, according to the above-described embodiment, the radome 32 corresponds to a cover portion. The unit antenna 344 corresponds to an antenna. The radome opposing surface 321 corresponds to an outer surface of the cover portion. In addition, the substantially square shape of which the length of one side is the width D corresponds to a predetermined shape. The x-axis direction and the y-axis direction correspond to the specific direction. The pitch interval P corresponds to a predetermined interval. Furthermore, the straight line of which the line width is the pitch interval P corresponds to the predetermined shape. The x-axis direction and the y-axis direction correspond to the specific direction. The width D corresponds to the predetermined interval. In addition, the x-axis direction corresponds to a first direction and the y-axis direction corresponds to a second direction.

### 4. Modifications

A basic configuration of a first modification is similar to that according to the above-described embodiment. Therefore, differences will be described below. Here, reference numbers that are the same as those according to the above-described embodiment indicate identical configurations. Earlier descriptions are referenced.

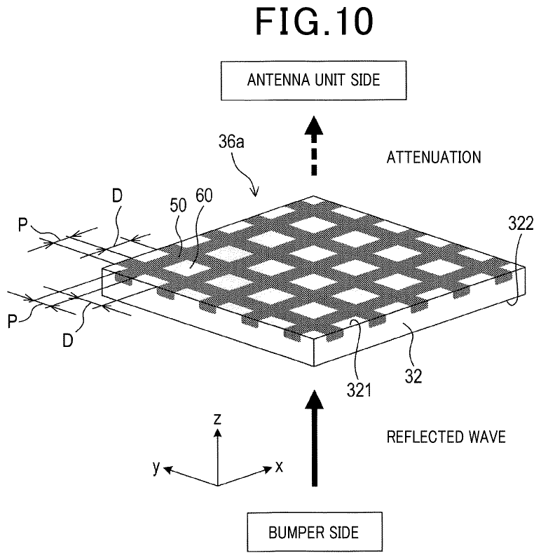

In the radar apparatus 1 of the first modification, a radio-wave suppression portion 36a is provided in the radome 32. As shown in FIG. 10, the radio-wave suppression portion 36a does not include the protruding portion 70. In the radio-wave suppression portion 36a, the conductive portions 50 that have a shape of a straight line of which the line width is the above-described pitch interval P are arrayed at every interval of the above-described width D along the x-axis direction and the y-axis direction. That is, in the radio-wave suppression portion 36a, the conductive portions 50 are arrayed perpendicular to each other in a lattice shape. As a result, effects similar to above-described (3a) to (3c) and (3h) can be achieved.

### 5. Measurement

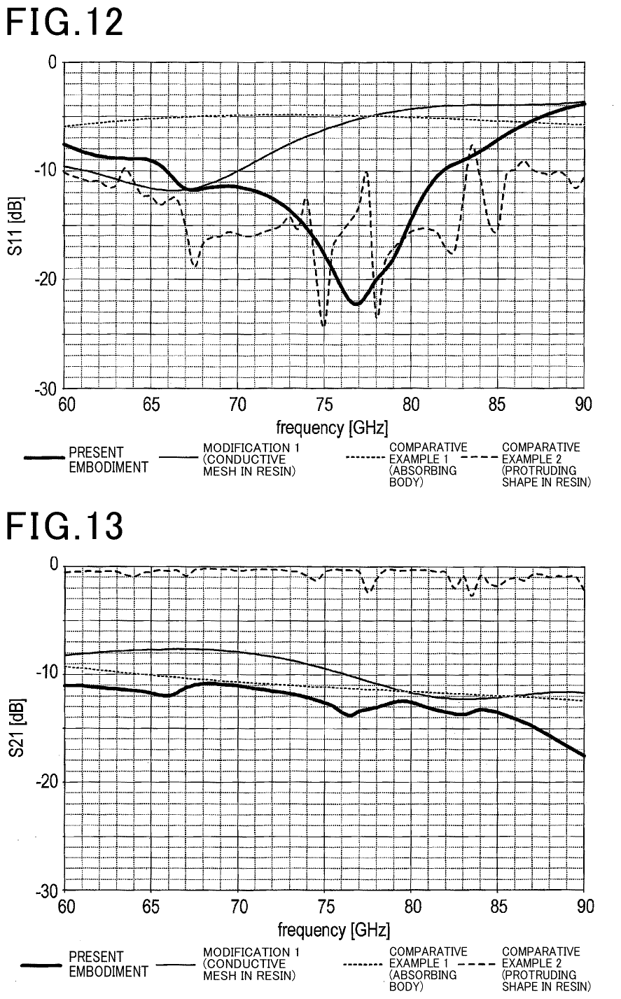

FIG. 12 shows results of S11 that have been calculated by simulation within a range of 60 GHz to 90 GHz, based on signals acquired by the antenna unit 341. A thick solid line indicates the embodiment of the present disclosure and a thin solid line indicates the first modification. A short-dash line indicates a comparative example 1 described hereafter, and a long-dash line indicates a comparative example 2 described hereafter. According to the embodiment, λ=about 4 mm (that is, about 1 wavelength of a radio wave in a 77 GHz band that is the target radio wave), D=about 1 mm (that is, about λ/4), H=about 1 mm, and P=about 1 mm.

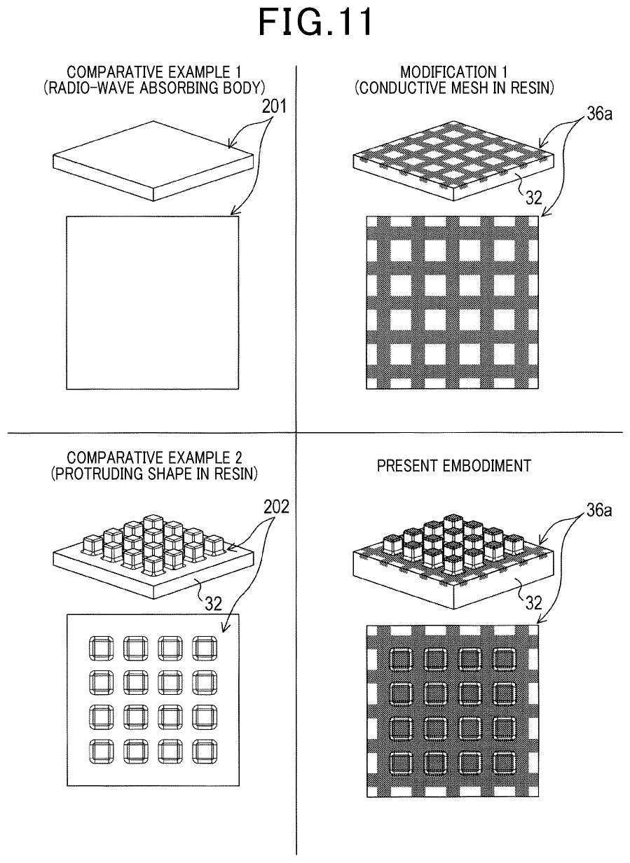

As shown in FIG. 11, a radio-wave absorbing body 201 (that is, the absorbing element) is provided instead of the radio-wave suppression portion 36 in the same area as the formation area 44 in the plate-shaped radome 32 that does not include the protruding portions 70. As the radio-wave absorbing body 201, PBT in which carbon fibers are mixed as a filler is used. In the comparative example 1, the radio-wave absorbing body 201 is formed by two-color molding, by the same area of the radome 32 as the formation area 44 being formed by PBT in which carbon fibers are mixed as a filler and a remaining portion being formed by PBT in which carbon fibers are not mixed as a filler.

In the comparative example 2, the radome 32 is formed using PBT. In the comparative example, the protruding portions 70 and the non-protruding portion 71 similar to those of the radio-wave suppression portion 36 according to the embodiment of the present disclosure are formed in the radome 32, and neither of the protruding portions 70 and the non-protruding portion 71 includes the conductive portions 50.

In the first modification, as described above, the conductive portions 50, having a shape of a straight line of which the line width is the pitch interval P, are arrayed at every interval of width D along the x-axis direction and the y-axis direction in the radome 32 in which PBT is formed into a plate shape and the protruding portions 70 are not formed.

According to the embodiment of the present disclosure, it is clear that S11 is less than that in the comparative example 1 and the comparative example 2 (that is, the unwanted waves are significantly suppressed), particularly near the frequency of the target radio wave (that is, 77 GHz). That is, it is clear that the above-described unwanted waves that may be reflected by the radome 32 and propagate toward the bumper 8 are significantly suppressed.

In addition, in the first modification, it is clear that S11 is less than that in the comparative example 1 (that is, the unwanted waves are significantly suppressed) at frequencies lower than the frequency of the target radio wave and substantially the same as that in the comparative example 1 at frequencies higher than the frequency of the target radio wave. That is, it is clear that the above-described unwanted waves that may be reflected by the radome 32 and propagate toward the bumper 8 are suppressed to the same extent as that in the comparative example 1 or greater.

FIG. 13 shows results of S21 that have been calculated by simulation within a range of 60 GHz to 90 GHz, based on signals acquired by the antenna unit 341.

According to the embodiment of the present disclosure, it is clear that S21 is the same or less than that in the comparative example 1 (that is, transmissive waves are significantly suppressed) over substantially the overall range of 60 GHz to 90 GHz. That is, it is clear that the unwanted waves that are the reflected waves from the bumper 8 that may pass through the radome 32 and be reflected multiple times inside the housing are suppressed to the same extent as that in the comparative example 1 or greater.

In addition, in the first modification, it is clear that S21 is about the same as that in the comparative example 1. That is, it is clear that the unwanted waves that are the reflected waves from the bumper 8 that may pass through the radome 32 and be reflected inside the housing are suppressed to the same extent as that in the comparative example 1.

In this manner, it is clear that the radio-wave suppression portion 36 of the present disclosure and the radio-wave suppression portion 36a of the first modification are portions that are integrated with the radome 32, and are portions that are capable of significantly suppressing unwanted waves to the same extent (that is, as favorably) as the comparative example 1 (that is, the absorbing element) or greater. Consequently, it is clear that the radio-wave suppression portion 36 of the present disclosure and the radio-wave suppression portion 36a of the first modification have an effect of suppressing orientation detection errors. Furthermore, it is clear that the radio-wave suppression portion 36 of the present disclosure has a greater effect of suppressing orientation detection errors than the radio-wave suppression portion 36a of the first modification.

### 6. Other Embodiments

An embodiment of the present disclosure is described above. However, the present disclosure is not limited to the above-described embodiment. Various modifications are possible.

(6a) Although not shown, in the above-described radar apparatus 1, the radio-wave suppression portions 36 and 36a may be configured such that the conductive portion 50 is insulated by at least the conductive portion 50 being covered by a film, a coating, an adhesive, or an adhesive sheet. As a result, the conductive portion 50 can be insulated and carbonized resin peeling away from the conductive portion 50 can be suppressed. For example, from the perspective of suppressing peeling caused by differences in linear expansion and from the perspective of cost reduction through integration of steps, the same material as the material of the radome 32 is preferable as the film. However, the material is not necessarily required to have the same material property as the material of the radome 32, and acrylic, PET (that is, polyethylene terephthalate), PC (that is, polycarbonate), and the like can be used.

(6b) In the above-described radar apparatus 1, in the radio-wave suppression portions 36 and 36a, the conductive portions 50 that have the shape of a straight line of which the line width is the pitch interval P are arrayed at every interval of width D along the x-axis direction and the y-axis direction. However, the line width may not be fixed. In addition, the interval may not be fixed.

(6c) In the above-described radar apparatus 1, in the radio-wave suppression portions 36 and 36a, the conductive portion 50 has a predetermined shape, and a plurality of conductive portions 50 are arrayed at a predetermined interval along at least one predetermined specific direction. The predetermined shape may be a linear shape, a circular shape, a polygonal shape, an ellipse, or other various shapes. In addition, the specific direction may be a direction in which orientation detection can be performed by the antenna unit 341 or other arbitrary directions. The specific direction may be one direction or a plurality of directions. In addition, when the specific direction is a plurality of directions, the directions may be orthogonal to each other or may not be orthogonal to each other. In addition, the interval for arraying may be a predetermined fixed interval or may not be a predetermined fixed interval.

(6d) In the above-described radar apparatus 1, in the radio-wave suppression portions 36 and 36a, the protrusion height H of all protruding portions 70 may not be equal. In addition, the interval (that is, the above-described pitch interval P) between all protruding portions 70 may not be equal. The protrusion height H or the pitch interval P of the protruding portions 70 may each differ depending on the position of the protruding portion 70, based on the frequency of the unwanted wave to be suppressed. In addition, the shape of the protruding portion 70 is not limited to a cube and, for example, may be a circular column, a polygonal column, or other arbitrary shapes.

In addition, in the above-described radar apparatus 1, in the radio-wave suppression portion 36, of the protruding portions 70 and the non-protruding portion 71, the conductive portions 50 may be formed in only the protruding portions 70. Alternatively, the conductive portions 50 may be formed in only the non-protruding portion 71. In addition, in the above-described radar apparatus 1, in the radio-wave suppression portion 36, the conductive portion 50 may be formed on a side surface of the protruding portion 70 in addition to the top surface 324. Furthermore, in the above-described radar apparatus 1, in the radio-wave suppression portion 36, protruding portions that are similar to the protruding portions 70 may have a step-like shape in which the protruding portions are successively arrayed in a plurality of levels such as two levels, three levels, . . . along the x-axis direction, In addition, the conductive portions 50 can be formed on the top surface (that is, the surface in the negative direction of the z-axis that is the protruding direction) of each of the first level, second level, third level, . . .

(6e) In the above-described radar apparatus 1, in the radio-wave suppression portions 36 and 36a, a thickness of the conductive portions 50 (that is, a length in the z-axis direction of the carbonized portion) may not be uniform. Conductivity increases as the thickness of the carbonized portion increases. For example, in the radio-wave suppression portions 36 and 36a that are provided in portions in which the unwanted waves are to be further attenuated, the thickness of the conductive portion 50 may be greater than that of the conductive portion 50 that is provided in another portion.

(6f) In the above-described radar apparatus 1, the radio-wave suppression portions 36 and 36a may be provided in the overall area of the out-of-detection-range area 40 of the radome opposing surface 321. Alternatively, the radio-wave suppression portions 36 and 36a may be provided in a predetermined arbitrary area in the out-of-detection-range area 40 of the radome opposing surface 321. Furthermore, the radio-wave suppression portions 36 and 36a may be provided in one section of the out-of-detection-range area 40 of the radome opposing surface 321 or in a plurality of sections. Moreover, a size of the area (that is, the formation area 44) in which the radio-wave suppression portions 36 and 36a are provided may be a predetermined arbitrary size.

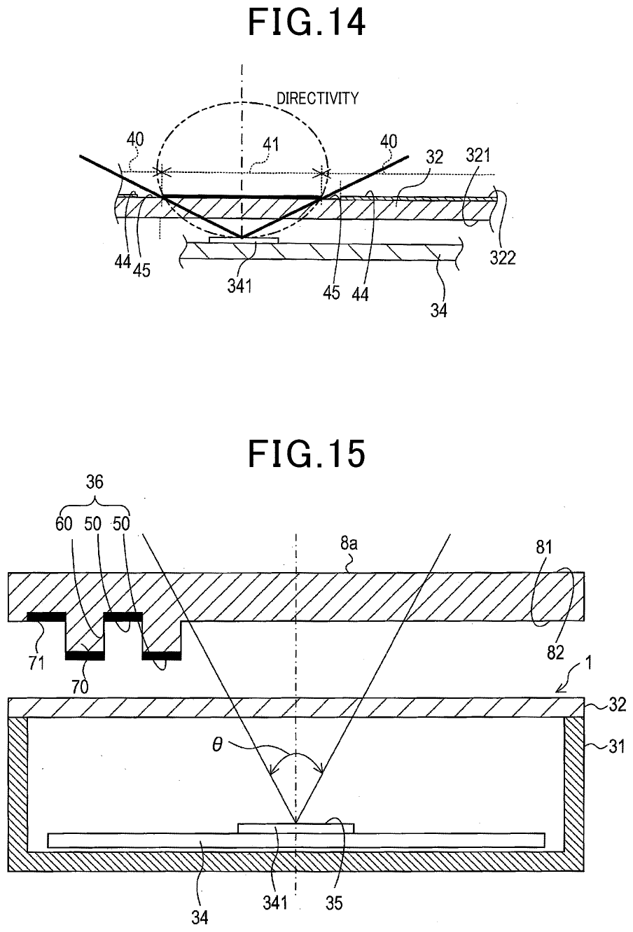

(6g) In the above-described radar apparatus 1, the radio-wave suppression portions 36 and 36a may be providing on the radome non-opposing surface 322, as shown in FIG. 14. In FIG. 14, the formation area 44 on the radome non-opposing surface 322 is shown. In FIG. 14, either of the radio-wave suppression portion 36 and 36a may be provided in the formation area 44. In this case, the radome 32 corresponds to the cover portion and the radome non-opposing surface 322 corresponds to the outer surface of the cover portion. Here, the radio-wave suppression portions 36 and 36a may be provided in at least one of the radome 32, the bumper 8, and an emblem.

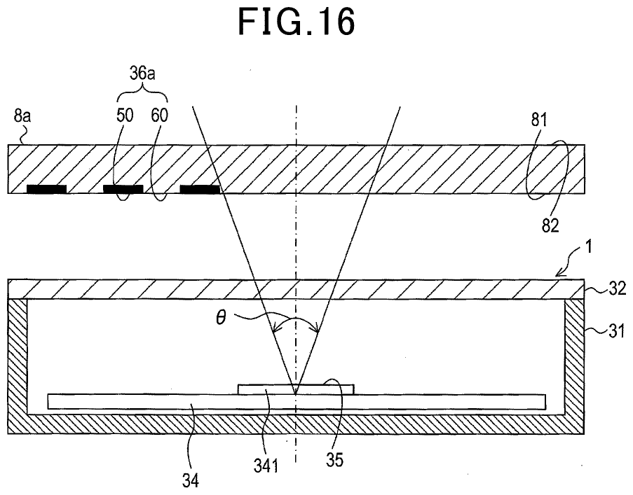

In the bumper 8, as shown in FIGS. 15 and 16, the radio-wave suppression portions 36 and 36a can be provided on a bumper opposing surface 81 that is a surface, among outer surfaces of the bumper 8, that opposes the antenna surface 35 (that is, a surface that opposes the radar apparatus 1). In this case, the bumper 8a corresponds to the cover portion and the bumper opposing surface 81 corresponds to the outer surface of the cover portion.

In addition, the radio-wave suppression portions 36 and 36a may be provided on a bumper non-opposing surface 82 that is a surface, among outer surfaces of a bumper 8a in FIGS. 15 and 16, on a side that does to oppose the antenna surface 35 (that is, a surface that does not oppose the radar apparatus 1). In this case, the bumper 8a corresponds to the cover portion and the bumper non-opposing surface 82 corresponds to the outer surface of the cover portion.

Here, the bumper 8a in FIGS. 15 and 16 may be replaced by an emblem of the vehicle. In the emblem that is attached to the vehicle, the radio-wave suppression portions 36 and 36a may be provided on a surface, among outer surfaces of the emblem, that opposes the antenna surface 35 (that is, the radar apparatus 1). In this case, the emblem corresponds to the cover portion and the surface, among the outer surfaces of the emblem, that opposes the antenna surface 35 corresponds to the outer surface of the cover portion.

Furthermore, the radio-wave suppression portion 36 may be provided on a surface, among the outer surfaces of the emblem that is attached to the vehicle, that does not oppose the antenna surface 35 (that is, the radar apparatus 1). In this case, the emblem corresponds to the cover portion and the surface, among the outer surfaces of the emblem, that does not oppose the antenna surface 35 corresponds to the outer surface of the cover portion.

(6h) In the above-described radar apparatus 1, in the radio-wave suppression portion 36, the conductive portions 50 may be integrated with the radome 32 by a metal (such as aluminum) being deposited on the radome 32, and formed to have conductivity. In addition, the conductive portions 50 may be integrated with the radome 32 by a thin film of metal being adhered to the radome 32 by an adhesive or the like, and formed to have conductivity.

(6i) In the above-described radar apparatus 1, as the resin that is the material of the radome 32, a resin in which a filler (that is, a filler agent) is mixed with the above-described resin may be used. As the filler, a material that increases strength of the resin as a result of being mixed therein and has conductivity as a result of being heated may be used. For example, glass fibers are used as the filler. In addition to the glass fibers, for example, aramid fibers, asbestos fibers, gypsum fibers, silica fibers, silica-alumina fibers, alumina fibers, zirconia fibers, silicon nitride fibers, silicon fibers, and potassium titanate fibers can be used.

(6j) The above-described radar apparatus 1 may be configured such that, in addition to the x-axis direction, the y-axis direction is also the orientation detection direction. In this case, in the antenna unit 341, the plurality of patch antennas 343 may be arranged in a manner similar to that according to the above-described embodiment. However, in addition to being capable of orientation detection in the x-axis direction by a method of use that is similar to that according to the above-described embodiment, the antenna unit 341 may also be capable of orientation detection in the y-axis direction through use of an array antenna that has a plurality of patch antennas 343 that are arrayed in a single row on the x axis as a unit antenna. As a result of the radar apparatus 1 such as this, the effect of suppressing orientation detection errors can be achieved not only in the x-axis direction, but also in the y-axis direction as well.

(6k) In the above-described radar apparatus 1, the transmission/reception circuit unit 341 may be arranged on a side opposite the antenna surface 35 of the circuit board 34, or may be arranged outside the lower case 31 and connected to the antenna unit 341 of the circuit board 34 by cable (not shown) or the like.

(6l) In the above-described radar apparatus 1, although not shown, the radome 32 may have an outer shape that is a rectangular parallelepiped and have a box-type shape of which one face thereof is open. That is, the radome 32 may have a cylindrical portion that is in the shape of a rectangular cylinder and a plate-shaped portion that is arranged to seal one opening of the cylindrical portion. The radio-wave suppression portion 36 may be provided in the plate-shaped portion. In addition, the housing may be formed by the radome 32 such as this and the lower case 31.

(6m) A plurality of functions provided by a single constituent element according to the above-described embodiments may be actualized by a plurality of constituent elements. A single function provided by a single constituent element may be actualized by a plurality of constituent elements. In addition, a plurality of functions provided by a plurality of constituent elements may be actualized by a single constituent element. A single function provided by a plurality of constituent elements may be actualized by a single constituent element. Furthermore, a part of a configuration according to the above-described embodiment may be omitted. Moreover, at least a part of a configuration according to an above-described embodiment may be added to or replace a configuration according to another of the above-described embodiments.

What is claimed is:

1. A radar apparatus comprising:
an antenna unit that includes an antenna surface in which one or more antennas that radiate radio waves are provided and is configured to emit a target radio wave of a predetermined frequency band;
a cover portion that is configured to be provided in a position through which the target radio wave passes; and
a radio-wave suppression portion that is integrated with the cover portion in an out-of-detection-range area of an outer surface of the cover portion, the out-of-detection-range area being an area that is outside a range of a detection angle of the antenna portion, and includes a conductive portion that has conductivity and a non-conductive portion that does not have conductivity, wherein:
the conductive portion is a portion in which a material property of the cover portion is changed.

2. The radar apparatus according to claim 1, wherein:
in the radio-wave suppression portion, the conductive portion has a predetermined shape and is arrayed at a predetermined interval along at least one predetermined specific direction.

3. The radar apparatus according to claim 2, wherein:
the radio-wave suppression portion has a plurality of protruding portions that have a shape that protrudes from the outer surface and a non-protruding portion that is a remaining portion of the outer surface excluding the protruding portions;
the protruding portions are arrayed at a predetermined interval along the specific direction; and
the conductive portion is provided in at least either of a surface of the protruding portions or the non-protruding portion.

4. The radar apparatus according to claim 3, wherein:
the radio-wave suppression portion includes the conductive portion in both the surface of the protruding portions and the non-protruding portion.

5. The radar apparatus according to claim 4, wherein:
a protrusion height of the protruding portion is an odd multiple of λ/4.

6. The radar apparatus according to claim 5, wherein:
the interval of the protruding portions is an odd multiple of λ/4.

7. The radar apparatus according to claim 6, wherein:
the specific direction includes a predetermined first direction and a predetermined second direction that is perpendicular to the first direction.

8. The radar apparatus according to claim 3, wherein:
a protrusion height of the protruding portion is an odd multiple of λ/4.

9. The radar apparatus according to claim 3, wherein:
the interval of the protruding portions is an odd multiple of λ/4.

10. The radar apparatus according to claim 2, wherein:
the specific direction includes a predetermined first direction and a predetermined second direction that is perpendicular to the first direction.
